(19) United States
(12) Patent Application Publication
(10) Pub. No.: US 2018/0046535 A1
(43) Pub. Date: Feb. 15, 2018

(54) INFORMATION PROCESSING APPARATUS, INFORMATION PROCESSING METHOD, AND COMPUTER READABLE STORAGE MEDIUM

(71) Applicant: FUJITSU LIMITED, Kawasaki-shi (JP)

(72) Inventor: Takahiro KONNO, Sagamihara (JP)

(73) Assignee: FUJITSU LIMITED, Kawasaki-shi (JP)

(21) Appl. No.: 15/671,560

(22) Filed: Aug. 8, 2017

(30) Foreign Application Priority Data
Aug. 15, 2016 (JP) 2016-159138

(51) Int. Cl. G06F 11/07

(52) U.S. Cl. CPC G06F 11/0787; G06F 11/079; G06F 11/0727; G06F 11/0775

(57) ABSTRACT

An information processing apparatus including: a memory configured to store information, each piece of the information associating a cause for shutdown of the information processing apparatus with one or more key inputs that respectively corresponds to one or more reboots triggered off by shutdown with the cause, and a processor coupled to the memory and the processor configured to: obtain a specified cause of a specified shutdown of the information processing apparatus, and for each reboot of one or more specified reboots triggered off by the specified shutdown with the specified cause, input a specified key input to the information processing apparatus, the specified key input corresponding to the reboot of the one or more specified reboots associated with the specified cause in the memory.

### CROSS-REFERENCE TO RELATED APPLICATION

This application is based upon and claims the benefit of priority of the prior Japanese Patent Application No. 2016-159138, filed on Aug. 15, 2016, the entire contents of which are incorporated herein by reference.

### FIELD

The embodiments discussed herein are related to an information processing apparatus, an information processing apparatus control method, and an information processing apparatus control program.

### BACKGROUND

There has been proposed a technique in which, if a screen image displayed during the booting of a server matches a screen image specified in advance, key data relevant to the screen image is transmitted to the server to automate key input during the booting of the server (for example, Japanese Laid-open Patent Publication Nos. 2011-39912 and 2014-49005)

### SUMMARY

According to an aspect of the invention, an information processing apparatus includes a memory configured to store information, each piece of the information associating a cause for shutdown of the information processing apparatus with one or more key inputs that respectively corresponds to one or more reboots triggered off by shutdown with the cause, and a processor coupled to the memory and the processor configured to: obtain a specified cause of a specified shutdown of the information processing apparatus, and for each reboot of one or more specified reboots triggered off by the specified shutdown with the specified cause, input a specified key input to the information processing apparatus, the specified key input corresponding to the reboot of the one or more specified reboots associated with the specified cause in the memory.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an embodiment of an information processing apparatus, an information processing apparatus control method, and an information processing apparatus control program;

FIG. 2 illustrates an example of an operation of the information processing apparatus illustrated in FIG. 1;

FIG. 3 illustrates another embodiment of an information processing apparatus, an information processing apparatus control method, and an information processing apparatus control program;

FIG. 4 illustrates another embodiment of an information processing apparatus, an information processing apparatus control method, and an information processing apparatus control program;

FIG. 5 illustrates an example of information held in a key information hold unit illustrated in FIG. 4;

FIG. 6 illustrates an example of information held in a boot order hold unit illustrated in FIG. 4;

FIG. 7 illustrates an example of information held in a cause hold unit illustrated in FIG. 4;

FIG. 8 illustrates an example of a shutdown program executed by a CPU illustrated in FIG. 4;

FIG. 9 illustrates an example of a processing of storing an order into a key information hold unit executed by a firmware of a BMC illustrated in FIG. 4;

FIG. 10 illustrates an example of a boot processing executed by a firmware of a BMC illustrated in FIG. 4;

FIG. 11 illustrates an example of a processing by a BIOS executed by the CPU during a boot-up of the server illustrated in FIG. 4;

FIG. 12 illustrates a continuation of the processing illustrated in FIG. 11;

FIG. 13 illustrates an example of a replacement procedure of a FC card in the server illustrated in FIG. 4; and

FIG. 14 illustrates an example of a boot-up operation of the server illustrated in FIG. 4.

### DESCRIPTION OF EMBODIMENTS

For example, when replacing an electronic component mounted on a server or when updating the firmware of the electronic component, the server is booted up multiple times (namely, the server is rebooted multiple times, which is triggered off by shutdown of the server), during which, in every boot-up, a boot screen is transitioned to a predetermined setup screen, and then the setup screen is used to set information or verify information. A type of a setup screen appearing in each of the boot-ups and the order of setup screens in the screen transition are different depending on the electronic component to be replaced or the electronic component of the firmware to be updated. For this reason, with the above technique of automating key input, it is difficult to make a transition from the boot screen to a predetermined setup screen at each of multiple boot-ups of the server.

According to one aspect of the present disclosure, an information processing apparatus, an information processing apparatus control method, and an information processing apparatus control program disclosed herein are intended to reduce a time for various settings during a boot-up of the information processing apparatus.

Hereinafter, embodiments are described with reference to the accompanying drawings.

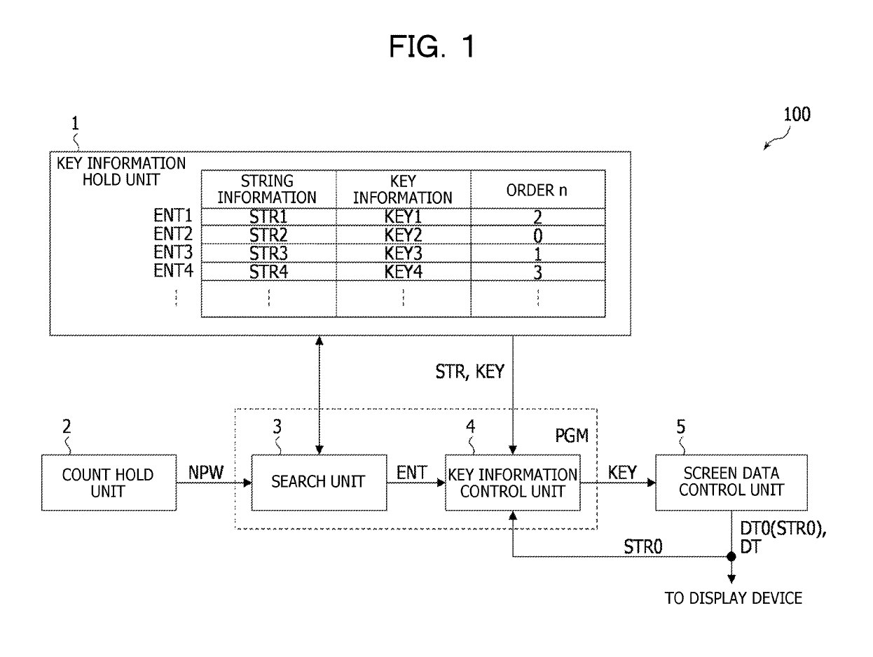

FIG. 1 illustrates an embodiment of an information processing apparatus, an information processing apparatus control method, and an information processing apparatus control program. An information processing apparatus 100 illustrated in FIG. 1 includes a key information hold unit 1, a count hold unit 2, a search unit 3, a key information control unit 4, and a screen data control unit 5. The information processing apparatus 100 is a server, a personal computer, and so on. For example, functions of the search unit 3 and the key information control unit 4 are implemented by a program PGM executed by a processor such as a central processing unit (CPU) (not illustrated) mounted in the information processing apparatus 100. The program PGM is recorded in a recording medium such as a flash memory. The functions of the search unit 3 and the key information control unit 4 may be implemented by hardware. In one non-limiting example, the functions of the key information hold unit 1, the count hold unit 2, the search unit 3, the key information control unit 4, and the screen data control unit 5 are implemented by a baseboard management controller (BMC) (not illustrated) mounted in the information processing apparatus 100.

The key information hold unit 1 includes multiple entries ENT (ENT1, ENT2, ENT3, ENT4, . . . ). Each of the entries ENT includes an area where string information STR (STR1, STR2, STR3, STR4, ...), key information KEY (KEY1, KEY2, KEY3, KEY4, . . . ), and a boot processing (or reboot processing) order n are stored. The entry ENT is provided in association with a boot processing which may possibly be executed, after shutdown, depending on a cause for the shutdown of the information processing apparatus 100. The boot processing used herein is a processing in which information set in the peripheral devices and the like mounted in the information processing apparatus 100 is verified or changed depending on a shutdown cause during a boot-up after shutdown. For example, the key information hold unit 1 is provided in a rewritable non-volatile memory configured to hold information even when power is off.

The string information STR indicates a string (or a character string) included in a boot screen displayed on a display device during a boot-up of the information processing apparatus 100 after shutdown. During a boot-up after shutdown, the information processing apparatus 100 may display only one boot screen or display multiple boot screens sequentially at time intervals.

The key information KEY indicates a key (or a key input) to be pressed to transition from the boot screen to a setup screen for executing a target boot processing. The order n indicates the ordinal number of a boot processing in a series of a predetermined number of boot processings to be executed depending on a shutdown cause, that is, indicates the ordinal number in the order of keys to be pressed while the boot screens are displayed over the entire series of the boot processings after shutdown. The order n is stored depending on the shutdown cause every time the information processing apparatus 100 is shut down. More specifically, the order n stored in the key information hold unit 1 is different depending on the shutdown cause. For example, the shutdown cause is inputted by a user (including an operator such as a system administrator and a maintenance personnel) of the information processing apparatus 100 into the information processing apparatus 100 in an event of shutdown.

In FIG. 1, the key information hold unit 1 indicates that at a first boot-up after shutdown, the boot screen is transitioned to a setup screen for key information KEY3 of an entry ENT3 in which “1” is stored in the order n. The key information hold unit 1 indicates that at a second boot-up after shutdown, the boot screen is transitioned to a setup screen for key information KEY1 of an entry ENT1 in which “2” is stored in the order n. The key information hold unit 1 indicates that at a third boot-up after shutdown, the boot screen is transitioned to a setup screen for key information KEY4 of an entry ENT4 in which “3” is stored in the order n. As there exists no entry ENT in which “4” is stored in the order n, the third boot processing completes the series of the boot processings for the shutdown cause. An entry ENT in which “0” is stored in the boot processing order n indicates an unused entry.

The count hold unit 2 holds a count NPW indicating how many times the information processing apparatus 100 is booted up after shutdown. The information processing apparatus 100 is booted up when powered on or when reset while being powered. For example, the count hold unit 2 is provided in a rewritable non-volatile memory configured to hold information even when the power is off. The count NPW held in the count hold unit 2 is reset to “0” at the time of shutdown, and incremented by “1” at each boot-up after shutdown.

The search unit 3 searches a target entry ENT holding the order n equal to the boot count NPW held in the count hold unit 2 among multiple entries ENT, and notifies the key information control unit 4 of the retrieved target entry ENT.

The key information control unit 4 reads the string information STR and the key information KEY held in the target entry ENT from the key information hold unit 1. The key information control unit 4 monitors a string STR0 included in data DT0 for display on the boot screen outputted from the screen data control unit 5. The string STR0 includes a string prompting key press-down on the boot screen for transition to the setup screen. When a string indicated by the string information STR read from the key information hold unit 1 appears in the string STR0, the key information control unit 4 outputs the key information KEY read from the key information hold unit 1. For example, the key information KEY indicates a key code of a key pressed down for transition from the boot screen to the setup screen, and is outputted to the screen data control unit 5.

During a boot-up of the information processing apparatus 100, the screen data control unit 5 outputs the data DT0 for display of at least one boot screen to the display device. After outputting the data DT0, the screen data control unit 5 outputs, to the display device, data DT for display of a setup screen for the key information KEY outputted by the key information control unit 4. Thus, the boot screen may be automatically transitioned to the setup screen without causing the user of the information processing apparatus 100 to press down a key in accordance with the boot screen including a string prompting the user to press down the key for transition to the setup screen.

The information processing apparatus 100 may include a controller chip configured to output, based on the key information KEY received from a keyboard by press-down of a key (not illustrated) of the keyboard, data for display of a setup screen for the key information KEY to the screen data control unit 5. In this case, the key information control unit 4 outputs the key information KEY to the controller chip, and the screen data control unit 5 outputs display data (including DT) outputted from the controller chip according to the key information KEY to the display device.

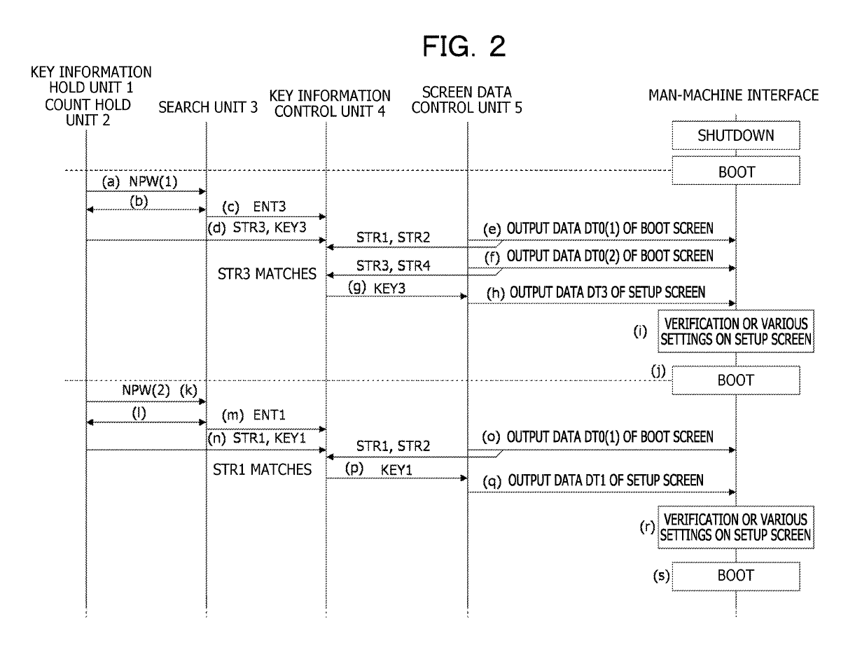

FIG. 2 illustrates an example of the operation of the information processing apparatus 100 illustrated in FIG. 1. More specifically, FIG. 2 illustrates an example of the control method of the information processing apparatus 100, and operations of the search unit 3 and the key information control unit 4 illustrated in FIG. 2 indicate an example of the control program of the information processing apparatus 100. In FIG. 2, the man-machine interface indicates input/output of information to and from input/output devices used by the user of the information processing apparatus 100, such as a keyboard, a mouse, and a display device. Before the state illustrated in FIG. 2, the user inputs the shutdown cause into the information processing apparatus 100 via the man-machine interface.

After a boot-up of the information processing apparatus 100 via the man-machine interface after shutdown, the boot count NPW held in the count hold unit 2 is incremented by one to 1. The boot count NPW may be incremented by the key information control unit 4 or by another control unit in the information processing apparatus 100. The search unit 3 reads the boot count NPW (1 time) from the count hold unit 2 ((a) of FIG. 2). Next, the search unit 3 detects a target entry ENT3 holding the order n (=“1”) equal to the boot count NPW by searching the key information hold unit 1, and notifies the key information control unit 4 of the information of the detected target entry ENT3 ((b) and (c) of FIG. 2). The key information control unit 4 reads the string information STR3 and key information KEY3 held in the target entry ENT3 from the key information hold unit 1 ((d) of FIG. 2). Provided in the non-volatile memory configured to store various information, the key information hold unit 1 and the count hold unit 2 are able to hold various information without loss even when the power of the information processing apparatus 100 is off.

The screen data control unit 5 outputs data DT0 (1) for display of the boot screen to the display device ((e) of FIG. 2). As the string STR3 is not included in strings STR1 and STR2 prompting press-down of a key for transition to a setup screen in a boot screen displayed by data DT0 (1), the key information control unit 4 suppresses output of the key information KEY3. After elapse of a predetermined time since output of data DT0 (1), the screen data control unit 5 outputs data DT0 (2) for display of a next boot screen to the display device ((f) of FIG. 2). As the string STR3 is included in strings STR3 and STR4 prompting press-down of a key in a boot screen displayed by data DT0 (2), the key information control unit 4 outputs the key information KEY3 to the screen data control unit 5 ((g) of FIG. 2).

The screen data control unit 5 outputs data DT3 for display of a setup screen for the key information KEY3 based on the received key information KEY3, and causes the display device to display the setup screen ((h) of FIG. 2). The user of the information processing apparatus 100 verifies the settings of the information processing apparatus 100 or performs various settings thereof based on a setup screen displayed on the display device, and restarts the information processing apparatus 100 ((i) and (j) of FIG. 2).

After a boot-up of the information processing apparatus 100, the boot count NPW held in the count hold unit 2 is incremented by one to 2. The search unit 3 reads the boot count NPW (2 times) from the count hold unit 2 ((k) of FIG. 2). The search unit 3 detects a target entry ENT1 holding the order n (=“2”) equal to the boot count NPW by searching the key information hold unit 1, and notifies the key information control unit 4 of the information of the detected target entry ENT1 ((l) and (m) of FIG. 2). The key information control unit 4 reads the string information STR1 and key information KEY1 held in the target entry ENT1 from the key information hold unit 1 ((n) of FIG. 2).

The screen data control unit 5 outputs data DT0 (1) for display of the boot screen ((o) of FIG. 2). As the string STR1 is included in strings STR1 and STR2 prompting press-down of a key for transition to a setup screen included in a boot screen displayed by data DT0 (1), the key information control unit 4 outputs the key information KEY1 to the screen data control unit 5 ((p) of FIG. 2).

The screen data control unit 5 outputs data DT1 for display of a setup screen for the key information KEY1 based on the received key information KEY1, and causes the display device to display the setup screen ((q) of FIG. 2). The user of the information processing apparatus 100 verifies the settings of the information processing apparatus 100 or performs various settings thereof based on a setup screen displayed on the display device, and reboots the information processing apparatus 100 ((r) and (s) of FIG. 2). Thereafter, operations same as (a) to (i) of FIG. 2 are executed for an entry ENT4 according to the boot count NPW (3 times), and thereby various settings of the information processing apparatus 100 based on the shutdown cause complete.

Thus, in the embodiment illustrated in FIGS. 1 and 2, the boot screen may be automatically transitioned to the setup screen without causing the user of the information processing apparatus 100 to press down a key in accordance with the boot screen prompting the user to press down a key for transition to the setup screen. More specifically, the boot screen may be transitioned to the setup screen without forcing the user to continuously monitor the boot screen in order not to miss a timing of key press-down. In other words, failure of displaying a desired setup screen due to missing of a timing of key press-down may be reduced, and thereby useless reboot of the information processing apparatus 100 due to a failure may be avoided. As there is no request to continuously monitor the boot screen, the boot processing of making various settings to the information processing apparatus 100 during a boot-up may be performed on multiple information processing apparatuses 100 in parallel.

Further, a setup screens relevant to the shutdown cause is automatically displayed sequentially in correspondence to each of multiple boot-ups after shutdown. Thus, the user of the information processing apparatus 100 may be released from a work of checking a key to be pressed every time and a work of checking a sequence of keys to be pressed. Therefore, the user may concentrate on the setting operation and verification operation on the setup screen. As a result, compared with conventional technique, efficiency of various settings during a boot-up of the information processing apparatus 100 may be improved, and a time for the various settings of the information processing apparatus 100 may be reduced.

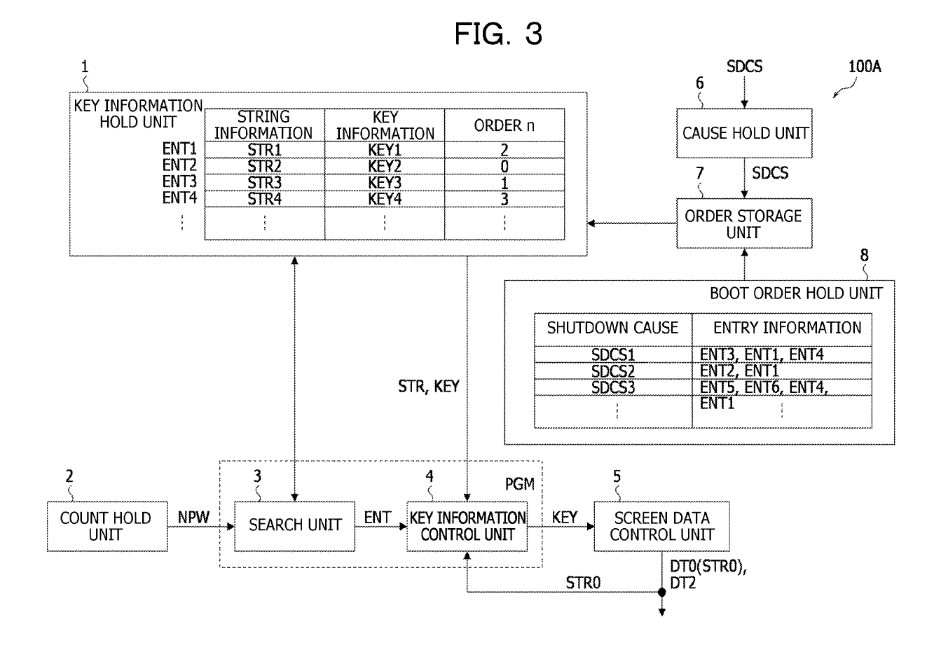

FIG. 3 illustrates another embodiment of the information processing apparatus, the information processing apparatus control method, and the information processing apparatus control program. Elements same as or similar to those elements described in the embodiment illustrated in FIG. 1 are assigned with the same reference numerals, and detailed description thereof is omitted. An information processing apparatus 100A illustrated in FIG. 3 includes a cause hold unit 6, an order storage unit 7, and a boot order hold unit 8, in addition to the configuration of the information processing apparatus 100 illustrated in FIG. 1. Although not limited particularly, functions of the key information hold unit 1, the count hold unit 2, the search unit 3, the key information control unit 4, the screen data control unit 5, the cause hold unit 6, the order storage unit 7, and the boot order hold unit 8 are implemented by a BMC mounted in the information processing apparatus 100A.

The cause hold unit 6 holds a shutdown cause SDCS inputted in an event of shutdown of the information processing apparatus 100A, and outputs the held cause SDCS to the order storage unit 7. A shutdown program executed by an OS of the information processing apparatus 100A notifies a controller of the BMC of a shutdown cause selected by the user of the information processing apparatus 100A among multiple shutdown causes. For example, in the event of shutdown, the user selects any one of multiple shutdown causes displayed on the display device with a mouse or the like. A controller such as the BMC stores the cause SDCS into the cause hold unit 6 based on the notification of the shutdown cause from the OS. For example, the cause hold unit 6 is provided in a rewritable non-volatile memory configured to hold information even when the power is off.

The information processing apparatus 100A is shut down when the information processing apparatus 100A is not used for a while after completion of data processing or when changing the state of the information processing apparatus 100A. For example, instances of changing the state of the information processing apparatus 100A include changing a setting of an electronic component mounted in the information processing apparatus 100A, replacing an electronic component, and updating a firmware of an electronic component. The number of boot-ups of the information processing apparatus 100A after shutdown differs depending on the shutdown cause (that is, depending on how the state of the information processing apparatus 100A is changed). For example, types of setup screens and the number of the setup screens (or boot count) invoked for updating a firmware of each of various cards detachably mounted in a card slot (not illustrated) of the information processing apparatus 100A are different depending on the card. Further, the types and number of the invoked setup screen are different between update of a firmware of the card and replacement of the card.

The order storage unit 7 stores the boot processing order n into the entries ENT of the key information hold unit 1 based on the shutdown cause SDCS stored in the cause hold unit 6 in the event of shutdown of the information processing apparatus 100A. For example, in the event of shutdown, the order storage unit 7 stores the boot processing order n into the entries ENT of the key information hold unit 1, based on the entry information held in the boot order hold unit 8 for the shutdown cause SDCS stored in the cause hold unit 6.

The boot order hold unit 8 holds, for each of shutdown causes SDCS, entry information in which a predetermined number of entries ENT respectively corresponding to a predetermined number of boot processings to executed after shutdown among multiple entries ENT in the key information hold unit 1 are indicated in association with the boot processing order. For example, the boot order hold unit 8 is provided in a rewritable non-volatile memory configured to hold information even when the power is off.

In the example illustrated in FIG. 3, when the shutdown cause is “SDCS1”, the order storage unit 7 stores “1” into an area of the order n of the entry ENT3 in the key information hold unit 1, and “2” into an area of the order n of the entry ENT1. Also, the order storage unit 7 stores “3” into an area of the order n of the entry ENT4 in the key information hold unit 1, and “0” into an area of the order n of other entries ENT.

When the shutdown cause is “SDCS2”, the order storage unit 7 stores “1” into an area of the order n of the entry ENT2 in the key information hold unit 1, “2” into an area of the order n of the entry ENT1, and “0” in an area of the order n of other entries ENT. When the shutdown cause is “SDCS3”, the order storage unit 7 stores “1” into an area of the order n of the entry ENT5 in the key information hold unit 1, “2” into an area of the order n of the entry ENT6, and “3” in an area of the order n of the entry ENT4. Then, the order storage unit 7 stores “4” into an area of the order n of the entry ENT1, and “0” into areas of the boot processing order n of the other entries ENT.

Thus, in the event of shutdown, the boot processing order n of the key information hold unit 1 is rewritten according to the shutdown cause SDCS. In an event of normal shutdown of the information processing apparatus 100A such as an event of shutdown in a case where the information processing apparatus 100A will not be used for a while after completion of data processing, the user does not select the shutdown cause or selects “no specific shutdown cause” with a mouse or the like. In this case, a controller such as the BMC stores an invalid shutdown cause into the cause hold unit 6 based on the notification of the “no specific shutdown cause” from the OS.

When an invalid shutdown cause is held in the cause hold unit 6, the order storage unit 7 stores “0” into the order n of all entries ENT in the key information hold unit 1. When starting up first time after shutdown, the search unit 3 detects that “1” is not stored in the order n of the key information hold unit 1, and outputs information indicating an invalid entry to the key information control unit 4. When information indicating an invalid entry is received, the key information control unit 4 does not access to the key information hold unit 1 and does not output the key information KEY. In this case, upon receiving the key information KEY from the keyboard, the screen data control unit 5 outputs display data of the setup screen for the received key information KEY to the display device. Alternatively, when the key information KEY is not received from the keyboard, the OS starts the boot processing.

Operation of the information processing apparatus 100A is the same as the operation illustrated in FIG. 2. More specifically, FIG. 2 illustrates an example of the control method of the information processing apparatus 100A, and operations of the search unit 3 and the key information control unit 4 illustrated in FIG. 2 indicate an example of the control program of the information processing apparatus 100A.

Thus, even in the embodiment illustrated in FIG. 3, efficiency of various settings at the boot-up of the information processing apparatus 100A may be improved, and a time taken for various settings of the information processing apparatus 100A may be reduced, as in the embodiment illustrated in FIG. 1.

Further, in the embodiment illustrated in FIG. 3, the order storage unit 7 stores the numeric values into the areas of the order n in the key information hold unit 1 based on the shutdown cause SDCS held in the cause hold unit 6. Thus, with the key information hold unit 1 used in common to multiple shutdown causes SDCS, the boot screen may be automatically transitioned to a setup screen relevant to the shutdown cause SDCS. As only the order n is rewritten, a time taken for setting information depending on the shutdown cause SDCS to the key information hold unit 1 may be reduced compared to a case where the entirety of the key information hold unit 1 is rewritten. Therefore, even when adding a processing to be set into the key information hold unit 1 at the time of shutdown, increase of the processing time due to the shutdown program may be minimized. Entry information indicating entries ENT used during a boot-up is held in the boot order hold unit 8 in advance for each of shutdown causes, and thereby the order storage unit 7 may store orders n for respective shutdown causes into the key information hold unit 1.

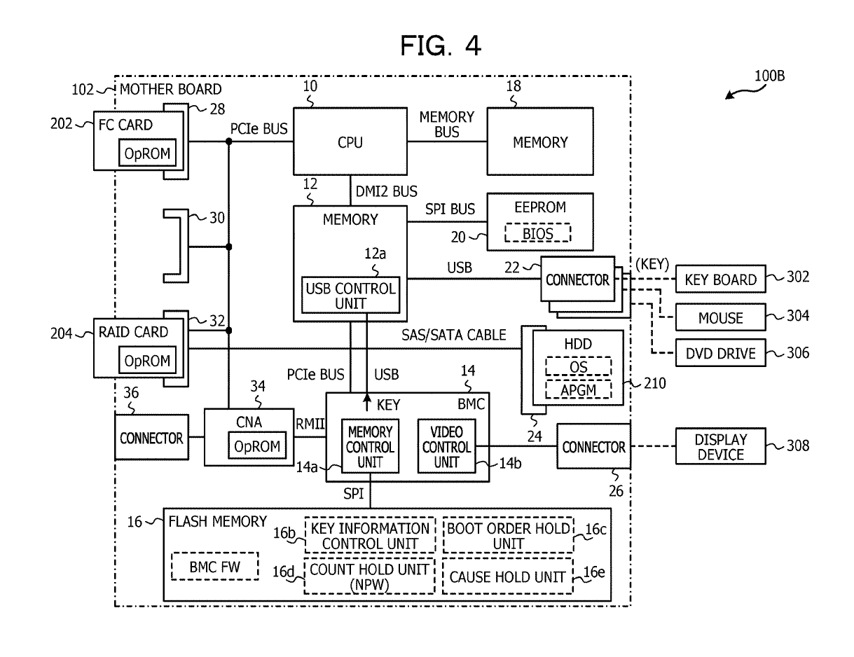

FIG. 4 illustrates another embodiment of the information processing apparatus, the information processing apparatus control method, and the information processing apparatus control program. Elements same or similar with those elements described in the embodiment illustrated in FIGS. 1 and 3 are assigned with same reference numerals, and detailed description thereof is omitted.

A server 100B illustrated in FIG. 4 includes a mother board 102 accommodated in a casing. The server 100B is an example of the information processing apparatus. The server 100B includes a CPU 10 mounted on the mother board 102, a chip set 12, a BMC 14, a flash memory 16, and a memory 18. The server 100B further includes an electrically erasable programmable read only memory (EEPROM) 20, multiple connectors 22 mounted on the mother board 102, and a backplane 24 to which a hard disk drive (HDD) 210 is coupled.

The server 100B further includes a connector 26, card slots 28, 30, 32, a converged network adapter (CNA) 34, and a connector 36.

The CPU 10 is coupled with the memory 18 via a memory bus, and coupled with card slots 28, 30, 32, and the CNA 34 via a peripheral component interconnect express (PCIe) bus. The CPU 10 is further coupled to the chip set 12 via a direct media interface 2 (DMI 2). The CPU 10 executes a basic input output system (BIOS) stored in the EEPROM 20 and an OS developed into the memory 18 from the HDD 210, and thereby controls entire operation of the server 100B and implements functions of the server 100B. Also, the CPU 10 executes an application program APGM developed into the memory 18 from the HDD 210, and thereby implements a desired function of executing a data processing and so on.

The chip set 12 is coupled with the EEPROM 20 via a Serial Peripheral Interface (SPI: registered trade mark) bus, with the connector 22 via a Universal Serial Bus (USB), and with the BMC 14 via the PCIe bus and the USB. A USB control unit 12a in the chip set 12 is configured to control information inputted and outputted via the connector 22, and receive the key information KEY from the BMC 14 via the USB. The connector 22 is coupled with a keyboard 302, a mouse 304, or a digital versatile disc (DVD) drive 306, and so on. The chip set 12 is configured to manage input and output of information among the EEPROM 20, connector 22, and BMC 14, and input and output information to and from the CPU 10 via the DMI2 bus.

The BMC 14 is configured to control supply voltage supplied to the CPU 10, clock frequency supplied to the CPU 10, and revolution of a fan (not illustrated). A memory control unit 14a in the BMC 14 is configured to control access to the flash memory 16 via the SPI bus. A video control unit 14b in the BMC 14 is configured to convert screen display data outputted from the chip set 12 into image data of, for example, the video graphics array (VGA) specification, and output image data obtained by the conversion to the connector 26. The connector 26 is coupled with a display unit 308 such as a liquid crystal display. The keyboard 302, mouse 304, and display unit 308 are an example of the man-machine interface. The BMC 14 is coupled with the CNA 34 via a reduced media independent interface (RMII) to output information to the CNA 34. The BMC 14 is configured to operate by executing firmware FW (BMC FM) stored in the flash memory 16. The firmware FW is an example of a control program executed by the BMC 14 configured to control the mother board 102. The flash memory 16 is an example of the recording medium that records the firmware FW. The CNA 34 is coupled with the connector 36 for the local area network (LAN).

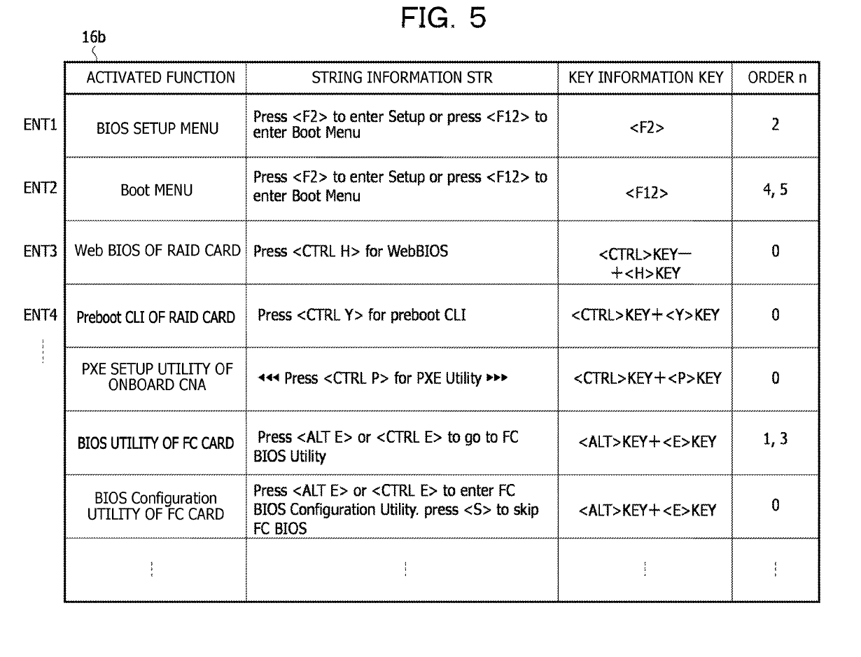

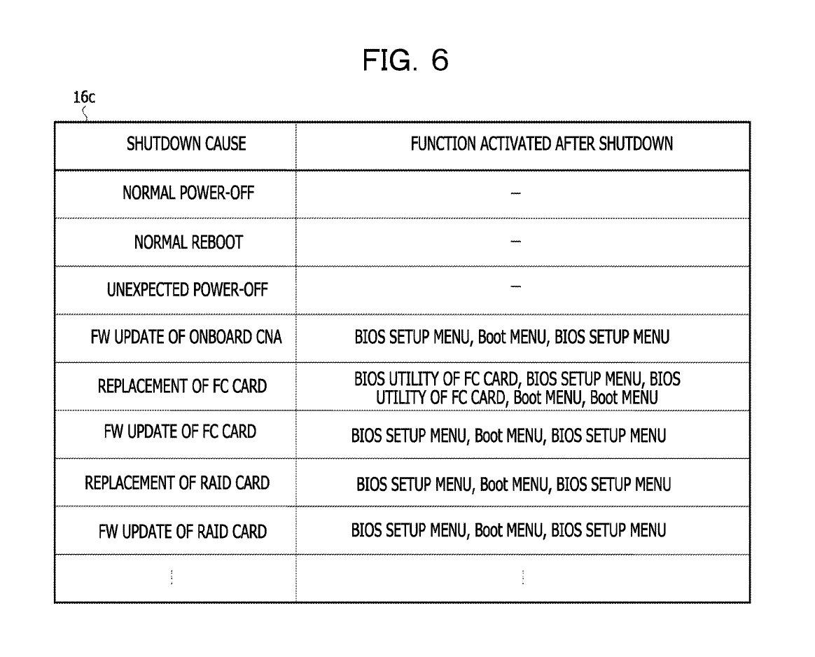

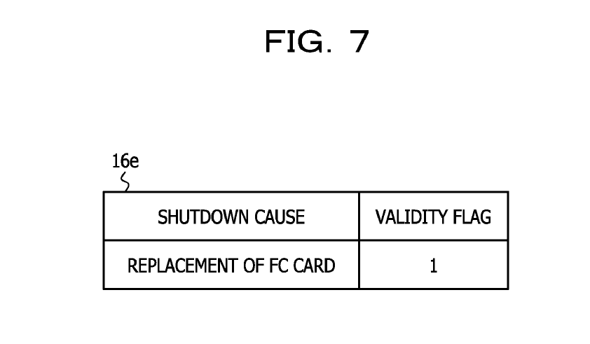

The flash memory 16 includes a storage area configured to store the firmware FW of the BMC 14, and a storage area into which a key information hold unit 16b, a boot order hold unit 16c, a count hold unit 16d, and a cause hold unit 16e are allocated. An example of information held in the key information hold unit 16b is illustrated in FIG. 5, an example of information held in the boot order hold unit 16c is illustrated in FIG. 6, and an example of information held in the cause hold unit 16e is illustrated in FIG. 7. The count hold unit 16d is configured to hold the boot count NPW after shutdown of the server 100B, like the count hold unit 2 illustrated in FIG. 1. The key information hold unit 16b, boot order hold unit 16c, count hold unit 16d, and cause hold unit 16e may be provided in another non-volatile memory accessible from the BMC 14, but not within the flash memory 16.

The memory 18 is, for example, a dual inline memory module (DIMM) in which multiple synchronous dynamic random access memory (SDRAM) are mounted. The memory 18 stores software such as an OS executed by the CPU 10 and an application program APG, and data used by the application program APGM. The EEPROM 20 stores the BIOS executed by the CPU 10.

Card slots 28, 30, 32 are coupled with various cards in a removable manner, and the card slot 32 is coupled to the backplane 24 via a SAS/SATA interface cable. In the example illustrated in FIG. 4, a fibre channel (FC) card 202 is mounted into the card slot 28, and a redundant arrays of inexpensive disk (RAID) card 204 is mounted into the card slot 32. The FC card 202, RAID card 204, and CNA 34 include an optional ROM (OpROM) in which a utility program (firmware) is stored. The backplane 24 may be coupled to a SAS/SATA controller (not illustrated) mounted on the mother board 102 instead of the card slot 32. In this case, the backplane 24 is coupled to the SAS/SATA controller via a wiring pattern of the SAS/SATA interface provided on the mother board 102.

FIG. 5 illustrates an example of information held in the key information hold unit 16b illustrated in FIG. 4. The key information hold unit 16b includes multiple entries ENT (ENT1, ENT2, ENT3, ENT4, . . . ) for the respective function activated at each time of multiple boot-ups after shutdown. Each entry ENT includes an area for storing a string representing “activated function”, “string information STR”, “key information KEY”, and boot processing “order n”.

The string representing the activated function is used for associating with the boot order hold unit 16c illustrated in FIG. 6, and indicates the content of the setup screen for each boot-up transitioned from the boot screen displayed during a boot-up after shutdown. The string information STR indicates a string (text data) displayed on any one of multiple boot screens displayed during the boot-up after shutdown. The key information KEY indicates a key pressed to transition from the boot screen to a setup screen for executing a target boot processing. In FIG. 5, keys to be pressed down are indicated by strings in bracket for better understanding. However, in practice, the area of “key information KEY” holds a key code representing a key to be pressed down. The boot processing order n indicates an ordinal number in the order of a predetermined number of boot processings to be executed depending on the shutdown cause, and “0” indicates an unused entry ENT.

FIG. 6 illustrates an example of information held in the boot order hold unit 16c illustrated in FIG. 4. The boot order hold unit 16c includes multiple areas for storing “shutdown cause” and “function activated after shutdown”. For example, the area of “shutdown cause” stores text data of strings illustrated in FIG. 6.

The area of “function activated after shutdown” stores strings stored in the area of “activated function” in the key information hold unit 16b illustrated in FIG. 5, in the ascending order of the boot processing order with each string separated by a comma, for each shutdown cause. The area of “function activated after shutdown” may store the numbers of the entries ENT of the key information hold unit 16b with the numbers separated from each other by commas. In this case, the key information hold unit 16b illustrated in FIG. 5 does not have the area of “activated function”. The area of “shutdown cause” may store a code (numeric value) representing each shutdown cause.

When the “shutdown cause” is boot-up after “normal power-off” of the server 100B or after “unexpected power-off” of the server 100B due to power failure or the like, or “normal reboot” of the server 100B, the BIOS activates the OS without activating the utility. For this reason, the area of “function activated after shutdown” corresponding to “normal power-off”, “normal reboot”, and “unexpected power-off” stores “−” indicating that there is no function activated after shutdown. For example, “normal power-off” indicates power-off of the server 100B after completion of data processing, and “normal reboot” indicates reboot of the server 100B to implement data processing.

FIG. 7 illustrates an example of information held in the cause hold unit 16e illustrated in FIG. 4. The cause hold unit 16e includes an area configured to store “shutdown cause” and “validity flag” indicating whether the cause hold unit 16e is valid or invalid. In FIG. 7, the area of “shutdown cause” stores any one of strings held in the area of “shutdown cause” of the boot order hold unit 16c illustrated in FIG. 6. However, in a case where a code (numeric value) corresponding to each cause is stored in the area of “shutdown cause” of the boot order hold unit 16c, the code is also stored in the area of “shutdown cause” of the cause hold unit 16e.

The validity flag “1” indicates that the cause hold unit e is valid, and the validity flag “0” indicates the cause hold unit e is invalid. In the event of shutdown of the server 100B, a shutdown program executed by the OS notifies the BMC 14 of the shutdown cause based on the item selected from the shutdown screen by the user of the server 100B. The BMC 14 stores the notified shutdown cause into the cause hold unit 16e. The BMC 14 may store a string (text data) indicating the shutdown cause into the cause hold unit 16e, or may store a code indicating the shutdown cause into the cause hold unit 16e.

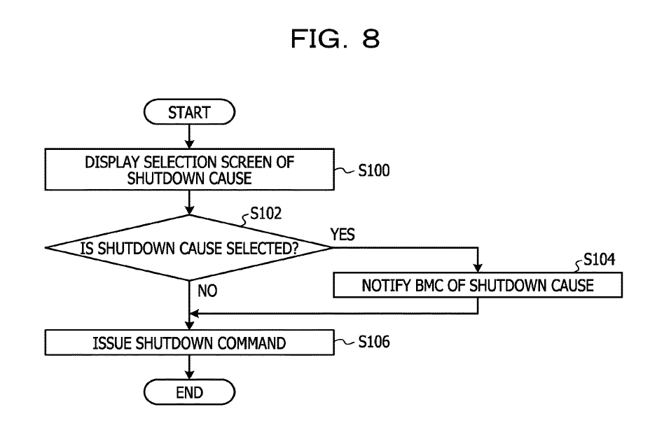

FIG. 8 illustrates an example of a shutdown program executed by the CPU 10 illustrated in FIG. 4. The shutdown program is activated by the OS based on detection of shutdown operation by the user of the server 100B.

In the step S100, the CPU 10 executing the shutdown program outputs data of a selection screen for selecting the shutdown cause to the display unit 308 via the chip set 12 and BMC 14. Next, in the step S102, when the user of the server 100B selects a shutdown cause based on the selection screen displayed on the display unit 308, the CPU 10 advances the processing to the step S104. When the user does not select the shutdown cause or in case of the normal power-off illustrated in FIG. 6, the CPU 10 advances the processing to the step S106.

In the step S104, the CPU 10 notifies the BMC 14 of the shutdown cause selected by the user, and advances the processing to the step S106. In the step S106, the CPU 10 (shutdown program) issues a shutdown command for shutting down the server 100B to the OS, and ends the processing. Thereafter, the OS executes the shutdown processing based on the shutdown command.

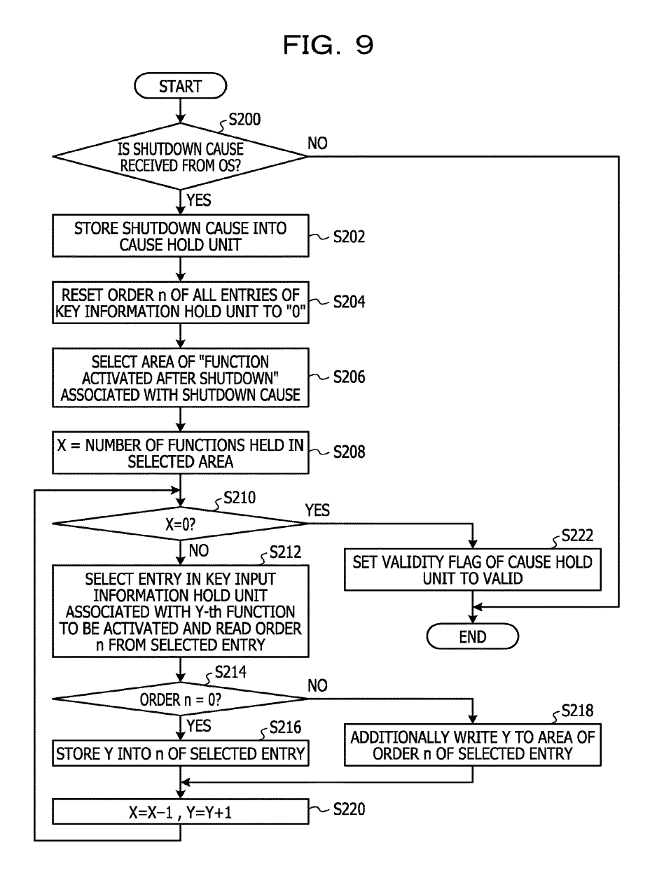

FIG. 9 illustrates an example of a processing of storing the order n into the key information hold unit 16b executed by the firmware FW of the BMC 14 illustrated in FIG. 4. More specifically, FIG. 9 illustrates an example of the control method of the server 100B, and an example of the control program of the server 100B. The processing illustrated in FIG. 9 is started at a predetermined cycle. The processing illustrated in FIG. 9 may be executed by the chip set 12, the CPU 10, or the like.

First, in the step S200, the BMC 14 determines whether the shutdown cause is received from the OS. If the shutdown cause is received from the OS, the processing proceeds to the step S202. If the shutdown cause is not received from the OS, the processing ends. When the shutdown cause is “normal power-off” or “unexpected power-off” illustrated in FIG. 6, the OS does not notify the BMC 14 of the shutdown cause, and therefore the processing illustrated in FIG. 9 is not executed. The processing illustrated in FIG. 9 is executed when the shutdown cause notified by the OS is any of the shutdown causes associated with the areas of “function activated after shutdown” holding valid information other than “−” in the boot order hold unit 16c illustrated in FIG. 6. In the step S202, the BMC 14 stores the shutdown cause received from the OS into the cause hold unit 16e.

Next, in the step S204, the BMC 14 resets the order n of all entries ENT in the key information hold unit 16b to “0”. Next, in the step S206, the BMC 14 selects, in the boot order hold unit 16c, the area of “function activated after shutdown” associated with the shutdown cause held in the cause hold unit 16e.

Next, in the step S208, the BMC 14 sets the number of functions held in the selected area to a variable X, and sets “1” to a variable Y. When the shutdown cause is “replacement of FC card”, the variable X is set to “5”. When the shutdown cause is “update of firmware of FC card”, the variable X is set to “3”. For example, the variable X is calculated by adding “1” to the number of commas held in the area of the selected “function activated after shutdown”.

Next, in steps S210 to S220, the BMC 14 executes a processing of storing the numeric value into the area of “order n” in the key information hold unit 16b. First, in the step S210, the BMC 14 determines whether the variable X is “0”. When the variable X is “0”, the BMC 14 determines that the processing of storing the order n into the key information hold unit 16b has completed, and advances the processing to the step S222. When the variable X is larger than “1”, the BMC 14 determines that the processing of storing the order n into the key information hold unit 16b is not completed, and advances the processing to the step S212.

In the step S212, the BMC 14 selects a Y-th function to be activated which is held in the area of “function activated after shutdown” selected in the step S206. Then, the BMC 14 selects the entry ENT of the key information hold unit 16b associated with the selected function, and reads a value held in the area of “order n” of the selected entry ENT.

Next, in the step S214, the BMC 14 determines whether the read value is “0”. When the read value is “0”, the processing proceeds to the step S216. When the read value is a value other than “0”, the processing proceeds to the step S218.

In the step S216, the BMC 14 stores the value of the variable Y into the area of “order n” of the entry ENT selected in the key information hold unit 16b, and advances the processing to the step S220. On the other hand, in the step S218, the BMC 14 additionally writes the value of the variable Y to the area of “order n” of the entry ENT selected in the key information hold unit 16b. More specifically, in a case where the order n is already held in the area of “order n” of the selected entry ENT, the BMC 14 stores a new order n in addition to the order n kept held. In the step S220, the BMC 14 decrements the variable X by “1”, increments the variable Y by “1”, and advances the processing to the step S210.

For example, in a case where the shutdown cause is “replacement of FC card”, and “Y” is “2”, the BMC 14 selects “BIOS setup menu” in the second place of “function activated after shutdown”. Then, the BMC 14 stores the value of Y (or “2”) into the area of “order n” of the entry ENT1 associated with “BIOS setup menu” in the key information hold unit 16b.

In the step S222, the BMC 14 sets the validity flag of the cause hold unit 16e to valid (or “1”) and ends the processing. Thereafter, the BMC 14 stops supply of the power to the CPU 10 and memory 18, and ends the shutdown processing. The BMC 14 executing the processing illustrated in FIG. 9 is an example of the order storage unit configured to store, at the time of shutdown, the boot processing order n into multiple entries ENT of the key information hold unit 16b based on the shutdown cause stored in the cause hold unit 16e.

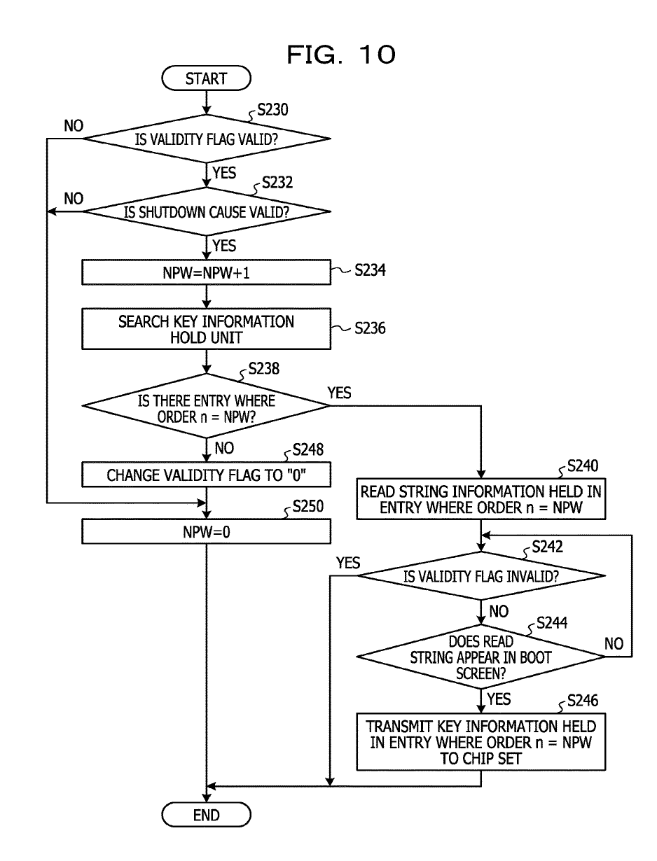

FIG. 10 illustrates an example of a boot processing executed by the firmware FW of the BMC 14 illustrated in FIG. 4. More specifically, FIG. 10 illustrates an example of a control method of the server 100B, and an example of a control program of the server 100B. The processing illustrated in FIG. 10 is started according to a boot-up instruction from the BIOS, the boot-up instruction being issued when the server 100B is booted up. The processing illustrated in FIG. 10 may be executed by the chip set 12, the CPU 10, or the like. However, a device executing the processing illustrated in FIG. 10 has a function of monitoring display data displayed on a display device 308, and a function of outputting the key information KEY to the chip set 12.

In the step S230, the BMC 14 determines whether the validity flag of the cause hold unit 16e is valid. When the validity flag is valid (or “1”), the processing proceeds to the step S232. When the validity flag is invalid (or “0”), the processing proceeds to the step S250. For example, when the shutdown cause is “normal power-off” or “unexpected power-off” illustrated in FIG. 6, the processing illustrated in FIG. 9 is not executed, and therefore the validity flag is kept in the invalid state.

A setup screen of each of the functions held in “function activated after shutdown” illustrated in FIG. 6 displays a select button for selecting cancel of the setup processing. The user of the server 100B may cancel the setup processing by selecting the select button. When the setup processing is canceled, the BMC 14 sets the validity flag of the cause hold unit 16e to invalid. Thus, a processing of transmitting the key information to the chip set 12 in the step S246 described later is not executed, and therefore automatic transition from the boot screen to the setup screen may be canceled. More specifically, even when the shutdown cause is held in the cause hold unit 16e, the server 100B may be booted up normally after shutdown by setting the validity flag to invalid.

In the step S232, the BMC 14 determines whether the shutdown cause held in the cause hold unit 16e is valid. When the shutdown cause held in the cause hold unit 16e exists in the area of “shutdown cause” of the boot order hold unit 16c, the BMC 14 determines that the shutdown cause is valid, and advances the processing to the step S234. When the shutdown cause held in the cause hold unit 16e does not exist in the area of “shutdown cause” of the boot order hold unit 16c, the BMC 14 determines that the shutdown cause is invalid, and advances the processing to the step S250. The case where the shutdown cause is determined invalid is caused by a malfunction of the server 100B, and therefore does not occur when the server 100B operates normally.

In the step S234, the BMC 14 increments the boot count NPW held in the count hold unit 16d by “1”. The boot count NPW corresponds to the order n of the key information hold unit 16b. The boot count NPW held in the count hold unit 16d is initialized to “0” in the default state where the processing illustrated in FIG. 10 is started.

Next, in the step S236, the BMC 14 searches all the entries ENT of the key information hold unit 16b by using the boot count NPW held in the count hold unit 16d. Next, in the step S238, the BMC 14 determines based on the search result in the step S236 whether an entry ENT in which the order n is the same value as the count NPW exists in the key information hold unit 16b. When there exists an entry ENT in which the order n is the same value as the count NPW, the processing proceeds to the step S240. When there exists no entry ENT in which the order n is the same value as the count NPW, the processing proceeds to the step S248. The BMC 14 executing steps S234, S236, and S238 is an example of the search unit that searches for a target entry ENT holding an order n equal to the boot count NPW held in the count hold unit 16d among multiple entries ENT in the key information hold unit 16b.

In the step S240, the BMC 14 reads string information STR held in the area of “string information STR” of the entry ENT in which the order n is the same value as the count NPW. Next, in the step S242, the BMC 14 determines whether the validity flag of the cause hold unit 16e is invalid. When the validity flag is invalid, the BMC 14 ends the processing. When the validity flag is valid, the BMC 14 advances the processing to the step S244. For example, in a case where time longer than a display period of the boot screen has passed, the BMC 14 sets the validity flag to invalid. Thus, useless iterations of the step S244 under the condition where a display period of the boot screen has expired may be suppressed.

In the step S244, the BMC 14 determines whether the string information STR read from the entry ENT in the step S240 is included in the boot screen. For example, the BMC 14 compares text data of a string indicated by the string information STR and text data of a string included in the boot screen with each other. When the string indicated by the string information STR read from the entry ENT is included in the boot screen, or when the string appears in a string prompting key press-down on the boot screen for transition to the setup screen, the processing proceeds to the step S246. On the other hand, when the string indicated by the string information STR read from the entry ENT is not included in the boot screen, the processing returns to the step S242.

In the step S246, the BMC 14 reads the key information KEY of an entry ENT in which the order n is the same value as the boot count NPW from the key information hold unit 16b, and outputs the read key information KEY to the chip set 12. Then, the BMC 14 ends the boot processing. In the step S234, the boot count NPW held in a nonvolatile count hold unit 16d is added sequentially, and thereby the key information KEY may be transmitted in the correct order in multiple boot-ups after shutdown. The BMC 14 executing steps S244 and S246 is an example of the key information control unit that outputs the key information KEY held in a target entry ENT when a string held in the target entry ENT appears in a string prompting key press-down for transition to the setup screen.

The chip set 12 processes the key information KEY from the BMC 14 in the same manner as the input from the keyboard 302, and outputs display data of the setup screen to which the boot screen is transitioned by press-down of a key corresponding to the key information KEY, to the video control unit 14b of the BMC 14. The video control unit 14b generates image data to be displayed on the display device 308 based on display data of the setup screen, and outputs generated image data to the display device 308. The video control unit 14b is an example of the screen data control unit that outputs display data of the boot screen when the server 100B is booted up, and then outputs display data of the setup screen for a target entry ENT based on key information KEY outputted by the key information control unit (BMC 14).

On the other hand, in the step S248, the BMC 14 alters the validity flag of the cause hold unit 16e to invalid (or “0”). Next, in the step S250, the BMC 14 initializes the boot count NPW to “0”, and ends the boot processing. After ending the boot processing, the BMC 14 starts normal processing such as management of the supply voltage and clock frequency.

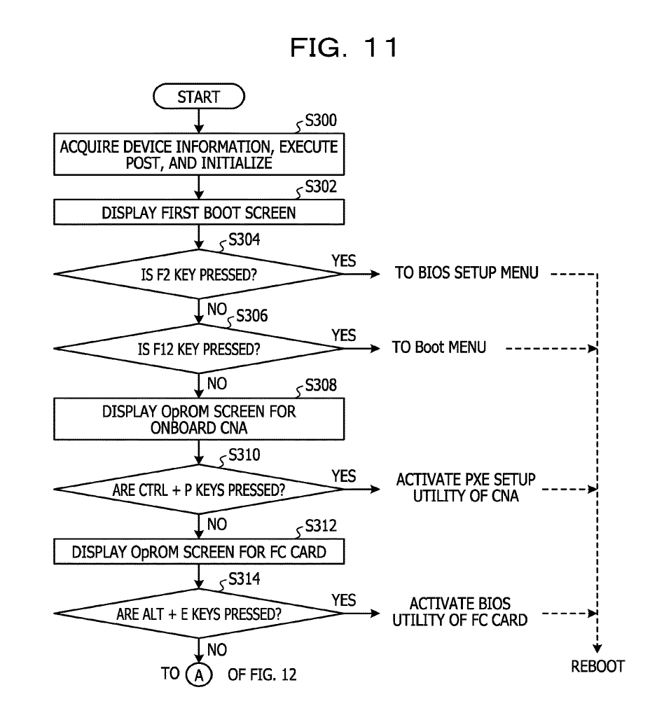

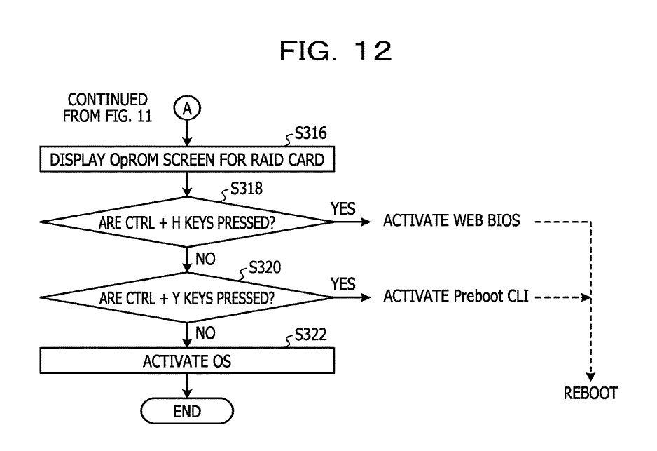

FIGS. 11 and 12 illustrate an example of a processing by the BIOS that the CPU 10 executes during a boot-up of the server 100B illustrated in FIG. 4. The processing illustrated in FIGS. 11 and 12 is started in response to the start of boot-up of the server 100B. FIG. 12 illustrates a continuation of the processing illustrated in FIG. 11.

First, in the step S300, the CPU 10 executing the BIOS acquires device information of the CNA 34 and various cards mounted in or coupled with the server 100B, executes a power on self-test (POST), and initializes the internal state of the server 100B. Based on the acquired device information, the CPU 10 determines the number (type) of the boot screen displayed on the display device 308 when the server 100B is booted up. The server 100B illustrated in FIG. 4 is provided with the CNA 34, and is coupled with the FC card 202 and the RAID card 204. Thus, the CPU 10 determines that a first boot screen is sequentially followed by a boot screen of the CNA 34, a boot screen of the FC card, and a boot screen of the RAID card 204.

Next, in the step S302, the CPU 10 causes the display device 308 to display a first boot screen. Next, in the step S304, the CPU 10 detects whether the F2 key is pressed. When press-down of the F2 key is detected, the CPU 10 causes the display device 308 to display a setup screen of the BIOS setup menu. When press-down of the F2 key is not detected, the CPU 10 advances the processing to the step S306. Press-down of the F2 key is detected not only when the F2 key of the keyboard 302 is actually pressed but also when key information KEY indicating the F2 key based on the step S246 illustrated in FIG. 10 is received from the BMC 14.

In the step S306, the CPU 10 detects whether the F12 key is pressed. When press-down of the F12 key is detected, the CPU 10 causes the display device 308 to display a setup screen of the Boot menu. When press-down of the F12 key is not detected, the CPU 10 advances the processing to the step S308. Press-down of the F12 key is detected not only when the F12 key of the keyboard 302 is actually pressed but also when key information KEY indicating the F12 key based on the step S246 illustrated in FIG. 10 is received from the BMC 14. In subsequent processings, key press-down is detected not only when a key of the keyboard 302 is actually pressed but also when key information KEY indicating a key is received from the BMC 14.

In the step S308, the CPU 10 causes the display device 308 to display an OpROM screen (boot screen) for the CNA 34 mounted on the mother board 102. Next, in the step S310, the CPU 10 detects whether the CTRL key and P key are pressed simultaneously. When press-down of the CTRL key and P key is detected, the CPU 10 activates a PXE setup utility of the CNA 34, and causes the display device 308 to display a setup screen. When press-down of the F12 key and P key is not detected, the CPU 10 advances the processing to the step S312.

In the step S312, the CPU 10 causes the display device 308 to display an OpROM screen (boot screen) for the FC card 202. Next, in the step S314, the CPU 10 detects whether the ALT key and E key are pressed simultaneously. When press-down of the ALT key and E key is detected, the CPU 10 activates the BIOS utility of the FC card 202, and causes the display device 308 to display a setup screen. When press-down of the ALT key and E key is not detected, the CPU 10 advances the processing to the step S316. Upon completion of the setup processing or verification processing in each of the setup screens, the server 100B is rebooted.

In the step S316 of FIG. 12, the CPU 10 causes the display device 308 to display an OpROM screen (boot screen) for the RAID card 204. Next, in the step S318, the CPU 10 detects whether the CTRL key and H key are pressed simultaneously. When press-down of the CTRL key and H key is detected, the CPU 10 activates a WEB IOS, and causes the display device 308 to display a setup screen. When press-down of the CTRL key and H key is not detected, the CPU 10 advances the processing to the step S320. In the step S320, the CPU 10 detects whether the CTRL key and Y key are pressed simultaneously. When press-down of the CTRL key and Y key is detected, the CPU 10 activates a preboot command line interface (CLI) and causes the display device 308 to display a setup screen. When press-down of the CTRL key and Y key is not detected, the processing proceeds to the step S322.

In the step S322, the CPU 10 (BIOS) issues an OS and ends the processing. Upon completion of the setup processing or verification processing on each of the setup screens, the server 100B is rebooted as in the case of FIG. 11.

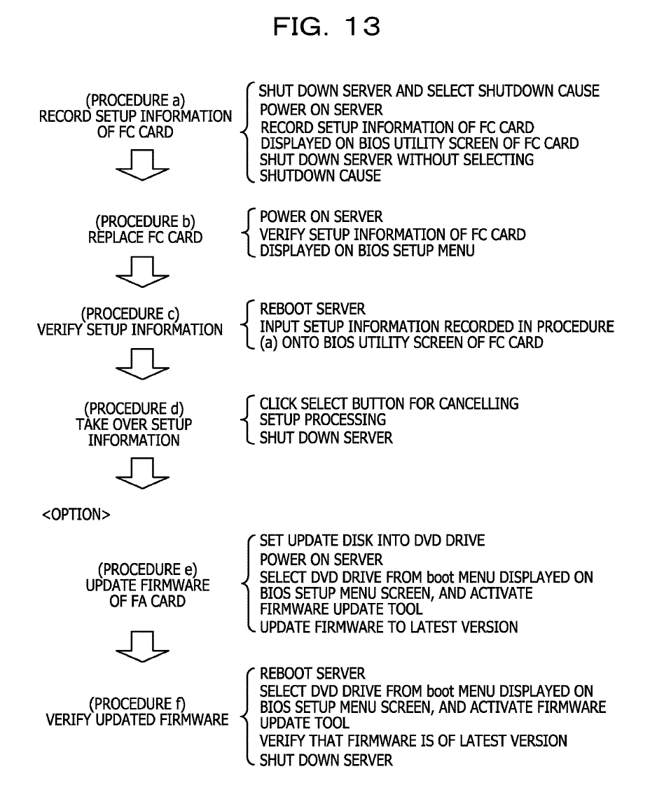

FIG. 13 illustrates an example of a replacement procedure of the FC card 202 in the server 100B illustrated in FIG. 4. When replacing the FC card 202, as illustrated in the procedure (a), the operator first executes a shutdown operation of the server 100B, and selects the shutdown cause (replacement of FC card 202) from a selection screen displayed on the display device 308. By selecting the shutdown cause, the server 100B is shut down. In the event of shutdown, the BMC 14 executes a flow illustrated in FIG. 9 and sets the key information hold unit 16b to a state where orders n are stored as illustrated in FIG. 5.

Next, the operator turns on the power of the server 100B. The BIOS is started by turning the power on, and displays boot screens of steps S302, S308, and S312 illustrated in FIG. 11 sequentially. Then, in the step S314, the BIOS receives key information KEY of the ALT key and E key from the BMC 14. Then, following the step S314, the BIOS displays a setup screen of the BIOS utility of the FC card 202.

Thus, the operator does not have to wait until the boot screen for the FC card 202 is displayed while watching the screen of the display device 308 and then cause transition of the screen to a setup screen of the BIOS utility by pressing the ALT key and E key. Thus, the operator may perform other works. The operator records setup information of the pre-replacement FC card 202 displayed on the setup screen of the BIOS utility for the FC card 202. Thereafter, the operator shuts down the server 100B. In this operation, as the operator does not select the shutdown cause, a previously selected shutdown cause (replacement of FC card 202) is maintained.

Next, in the procedure (b), the operator replaces the FC card 202. Next, in the procedure (c), the operator powers on the server 100B. After displaying the boot screen of the step S302 illustrated in FIG. 11, in the step S304, the BIOS receives key information KEY of the F2 key from the BMC 14. Then, following the step S304, the BIOS displays the setup screen of the BIOS setup menu. Even in this case, the operator does not have to wait for display of a screen prompting press-down of the F2 key while watching the screen of the display device 308. The operator verifies the type of the post-replacement FC card 202 and the setup information such as the version of the firmware displayed on the setup screen of the BIOS setup menu.

Next, in the procedure (d), the operator reboots the server 100B. The BIOS displays boot screens of steps S302, S308, and S312 illustrated in FIG. 11 sequentially, and then, in the step S314, receives key information KEY of the

ALT key and E key from the BMC 14. Then, following the step S314, the BIOS displays a setup screen of the BIOS utility of the FC card 202. The operator inputs setup information of the pre-replacement FC card 202 recorded in the procedure (a) by using the setup screen. Thus, setup information of the pre-replacement FC card 202 is taken over as setup information of the post-replacement FC card 202. Thereafter, the operator clicks a select button for canceling the setup processing displayed on the setup screen of the BIOS utility. Upon receiving an instruction to cancel the setup processing from the chip set 12, the BMC 14 sets the validity flag of the cause hold unit 16e to invalid. Thus, when the server 100B is booted up thereafter, activation of two “Boot menus” is disabled among the functions yet to be activated at the time of “replacement of FC card” of FIG. 6. Then, the operator shuts down the server 100B, and the basic procedure for replacing the FC card 202 ends.

Following procedures (a), (b), (c), and (d), optional procedures (e) and (f) described below are performed when updating the firmware of the FC card 202. When updating the firmware of the FC card 202, the operator shuts down the power of the server 100B without clicking a select button for canceling the setup processing displayed on the setup screen of the BIOS utility in the procedure (d). Thus, the validity flag of the cause hold unit 16e is kept in the valid state.

In the procedure (e), the operator sets, into the DVD drive 306, an update disk in which an updater is recorded. Next, the operator powers on the server 100B. After displaying the boot screen of the step S302 illustrated in FIG. 11, in the step S306, the BIOS receives key information KEY of the F12 key from the BMC 14. Then, following the step S306, the BIOS displays the setup screen of the Boot menu. Even in this case, the operator does not have to wait for display of a screen prompting press-down of the F12 key while watching the screen of the display device 308. The operator selects the DVD drive 306 from the setup screen of the Boot menu and activates an update tool of the firmware. Then, the operator verifies the type of the post-replacement FC card 202 and setup information such as the version of the firmware displayed on the setup screen of the BIOS setup menu.

Next, in the procedure (f), the operator reboots the server 100B. The BIOS displays the boot screen of the step S302 illustrated in FIG. 11 as in the procedure (e), and then displays the setup screen of the Boot menu based on the key information KEY of the F12 key received from the BMC 14. Even in this case, the operator does not have to wait for display of a screen prompting press-down of the F12 key while watching the screen of the display device 308. The operator verifies that the firmware updated on the setup screen of the Boot menu is of the latest version, and then shuts down the server 100B.

In a case where an encryption function for the file or disk is set to valid, the encryption function is disabled before starting the replacement procedure of FIG. 13. Then, after completion of the replacement procedure illustrated in FIG. 13, the encryption function is set to valid again. Thus, execution of the replacement procedure illustrated in FIG. 13 may not be hindered by the encryption function.

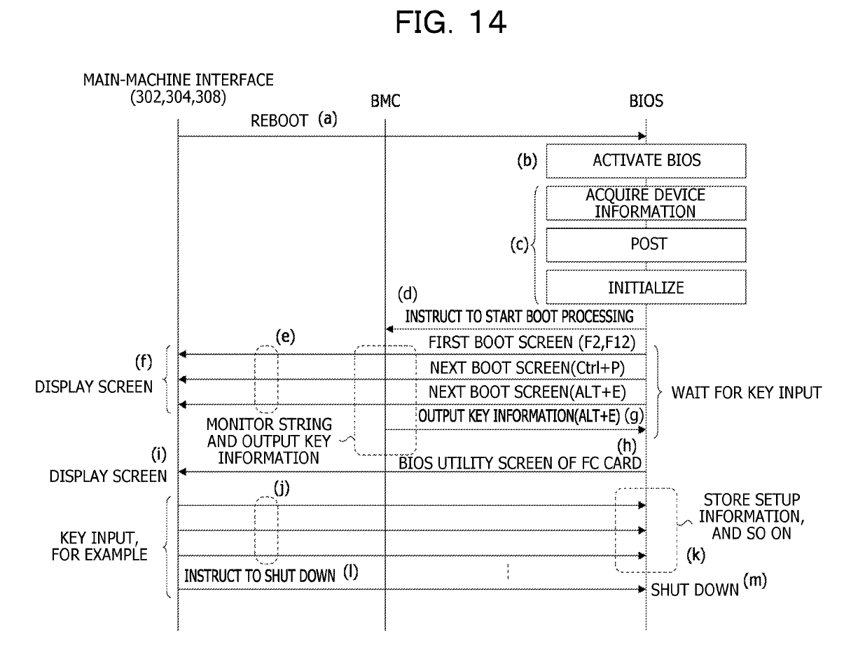

FIG. 14 illustrates an example of a boot-up operation of the server 100B illustrated in FIG. 4. FIG. 14 illustrates the operation in the procedure (d) illustrated in FIG. 13.

In the procedure (d), the operator instructs to reboot the server 100B via the man-machine interface ((a) of FIG. 14). The server 100B activates the BIOS based on the reboot instruction ((b) of FIG. 14). The activated BIOS acquires device information, executes POST, and initializes the internal state of the server 100B ((c) of FIG. 14).

After instructing the BMC 14 to start the boot processing, the BIOS outputs display data of boot screens illustrated in steps S302, S308, and S312 of FIG. 11 sequentially at predetermined time intervals ((d) and (e) of FIG. 14). Boot screens are sequentially displayed on the display device 308 ((f) of FIG. 14). The BMC 14 monitors strings included in display data of each of the boot screens. Then, the BIOS detects that the string “Press <ALT> or <CTRL E> to go to FC BIOS Utility” is included in display data of a third boot screen, and outputs the key information KEY (key code) for a case where ALT and E keys are pressed down at the same time ((g) of FIG. 14).

Based on the received key information KEY, the BIOS outputs the display data of the BIOS utility screen for the FC card 202 ((h) of FIG. 14). The boot screens are sequentially displayed on the display device 308 ((i) of FIG. 14). The operator inputs setup information recorded in the procedure (a) of FIG. 13 into the server 100B via the man-machine interface ((j) of FIG. 14). The BIOS stores the setup information received via the man-machine interface into the FC card 202 ((k) of FIG. 14). After completion of inputting the setup information, the operator inputs a shutdown instruction into the server 100B ((I) of FIG. 14). Then, the server 100B is shut down ((m) of FIG. 14).

Thus, even in the embodiment illustrated in FIGS. 4 to 14, similar effects to those in the embodiment illustrated in FIGS. 1 to 3 may be obtained. For example, the boot screen may be automatically transitioned to a setup screen without causing the operator of the server 100B to press down a key in accordance with the boot screen prompting press-down of a key for transition to a setup screen. As there is no request to continuously monitor the boot screen, the boot processing of making various settings to the server 100B at the boot-up may be performed for multiple servers 100B in parallel. The user of the server 100B may be released from a work of checking the key to be pressed every time and a work of checking the sequence of keys to be pressed. Thus, the user may concentrate on the setting work and the verification work on the setup screen. As a result, compared with conventional techniques, efficiency of various settings at the boot-up of the server 100B may be improved, and time taken for various settings of the server 100B may be reduced.

As the order n is stored into the key information hold unit 16b based on the shutdown cause held in the cause hold unit 16e, the boot screen may be automatically transitioned to a setup screen relevant to the shutdown cause by using the key information hold unit 16b in common. In this operation, the entry information indicating entries ENT to be used during boot-up may be held in the boot order hold unit 16c in advance for each of shutdown causes, and thereby orders n for respective shutdown causes may be stored into the key information hold unit 16b.

Further, in the embodiment illustrated in FIGS. 4 to 14, even when the shutdown cause is held in the cause hold unit 16e, the server 100B may be booted up normally after shutdown, by setting the validity flag to invalid. By sequentially incrementing the boot count NPW held in the count hold unit 16d, the BMC 14 may transmit key information KEY in the correct order of multiple boot-ups after shutdown.

Features and advantages of the embodiments will be apparent from the above detailed description. This intends that the appended claims cover the features and advantages of the above embodiments within a scope not deviating from the spirit and the scope of the right thereof. A person of ordinary skill in the art may easily conceive of any modification and variation. Therefore, it is not intended to limit the scope of embodiments having inventiveness to the foregoing, and appropriate modifications and equivalents included in the scope disclosed in the embodiments may be covered.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An information processing apparatus comprising:
a memory configured to store information, each piece of the information associating a cause for shutdown of the information processing apparatus with one or more key inputs that respectively corresponds to one or more reboots triggered off by shutdown with the cause; and
a processor coupled to the memory and the processor configured to:
obtain a specified cause of a specified shutdown of the information processing apparatus, and
for each reboot of one or more specified reboots triggered off by the specified shutdown with the specified cause, input a specified key input to the information processing apparatus, the specified key input corresponding to the reboot of the one or more specified reboots associated with the specified cause in the memory.

2. The information processing apparatus according to claim 1, wherein
the one or more specified reboots includes a first reboot and a second reboot,
for the first reboot, a first key input corresponding to the first reboot is inputted to the information processing apparatus, and
for the second reboot, a second key input corresponding to the second reboot is inputted to the information processing apparatus.

3. The information processing apparatus according to claim 1, wherein
in the memory, the one or more reboots respectively corresponds to one or more character strings,
for each reboot of the one or more specified reboots triggered off by the specified shutdown with the specified cause, the specified key input is inputted to the information processing apparatus when a specified string corresponding to the reboot is displayed.

4. The information processing apparatus according to claim 1, wherein
the specified key input is automatically inputted to the information processing apparatus.

5. The information processing apparatus according to claim 1, wherein the memory is a non-volatile memory.

6. An information processing method comprising:
storing information in a memory, each piece of the information associating a cause for shutdown of the information processing apparatus with one or more key inputs that respectively corresponds to one or more reboots triggered off by shutdown with the cause;
obtaining a specified cause of a specified shutdown of the information processing apparatus; and
for each reboot of one or more specified reboots triggered off by the specified shutdown with the specified cause, inputting a specified key input to the information processing apparatus, the specified key input corresponding to the reboot of the one or more specified reboots associated with the specified cause in the memory.

7. A non-transitory computer readable storage medium that stores a program that causes a information processing apparatus to execute a process comprising:
storing information in a memory, each piece of the information associating a cause for shutdown of the information processing apparatus with one or more key inputs that respectively corresponds to one or more reboots triggered off by shutdown with the cause;
obtaining a specified cause of a specified shutdown of the information processing apparatus; and
for each reboot of one or more specified reboots triggered off by the specified shutdown with the specified cause, inputting a specified key input to the information processing apparatus, the specified key input corresponding to the reboot of the one or more specified reboots associated with the specified cause in the memory.
